(19) United States
(12) Patent Application Publication
(10) Pub. No.: US 2019/0291262 A1
(43) Pub. Date: Sep. 26, 2019

(54) TOOL HANDLE

(71) Applicant: Sno go Shovels LLC, Arlington, SD (US)

(72) Inventor: Brandon Bunker, Arlington, SD (US)

(21) Appl. No.: 16/035,573

(22) Filed: Jul. 13, 2018

Related U.S. Application Data
(60) Provisional application No. 62/646,084, filed on Mar. 21, 2018.

(51) Int. Cl. B25G 1/10; E01H 5/02

(52) U.S. Cl. CPC B25G 1/102; E01H 5/02

(57) ABSTRACT

An improved tool handle is described. The improved handle combines a centered D-shaped through grip with two side grips that extend on each side of the D-shaped grip. The side grips extend along an axis that is perpendicular to the axis of an attached tool shaft. The handle is ergonomically designed to support both pushing and scooping capabilities. The handle can be used in “pushing mode” by gripping the side grips. Pushing mode can be employed when removing snow or similar material. The side grips provide leverage and allow a user to use body weight and arms for pushing, which also helps reduce strain and backaches. The handle can also be used in “scooping mode,” by using the D-shaped through grip. The D-shaped grip provides a user-friendly, comfortable handle for scooping material.

### PRIORITY CLAIM

This application claims the benefit of priority from U.S. Provisional Patent Application No. 62/646,084, entitled “T-HANDLE FOR SHOVEL OR OTHER TOOL,” filed on Mar. 21, 2018, the entire content of which is incorporated herein by reference in its entirety.

### TECHNICAL FIELD

The present disclosure relates to an improved handle for a shovel or other tool.

### BACKGROUND

Prior art shovel handles typically come in one of two styles: T-shaped and D-shaped. D-shaped handles are comfortable for scooping. T-shaped handles may also be used to provide grip and leverage. However, T-shaped handles are not considered as comfortable as D-shaped handles, due to the fact that the shovel shaft will run between the fingers of the user, causing irritation. Traditional D-shaped and T-shaped handles are relatively narrow, typically about the width of a human's hand. Narrow handle width means that such handles provide insufficient space or leverage for two-handed operation, such as when a shovel is being used to push material across a surface.

### BRIEF DESCRIPTION OF THE DRAWINGS

FIG. 1 is a line drawing showing a perspective view of the handle according to a first embodiment.

FIG. 2 is an image showing a perspective view of a tool that includes the handle according to the first embodiment.

FIG. 3A is a line drawing showing a top plan view of the handle according to the first embodiment.

FIG. 3B is a line drawing showing a front elevation view of the handle according to

FIG. 3C is a line drawing showing a left side elevation view of the handle according to the first embodiment.

### DETAILED DESCRIPTION

Embodiments described herein provide an improved handle. The improved handle (also referred to herein as “the handle”) combines a centered D-shaped through grip with two side grips that extend on each side of the D-shaped grip. The handle is ergonomically designed to support both pushing and scooping capabilities.

The handle can be used in “pushing mode” by gripping the side grips. Pushing mode can be employed when removing snow or similar material. The side grips provide leverage and allow a user to use body weight and arms for pushing, which also helps reduce strain and backaches.

The handle can also be used in “scooping mode,” by using the D-shaped through grip. The D-shaped grip provides a user-friendly, comfortable handle for scooping material. A conventional T-handle cannot be effectively or comfortably used for scooping, because the grip hand will either (1) rest on one side of the shaft or the other, leading to an imbalanced grip or (2) rest with the shaft between the fingers of the hand, which is difficult with mittens and/or can result in blistering/discomfort of the fingers. By combining the D-shaped grip and two side grips, the improved handle advantageously supports multiple use modes for a shovel or other tool.

The handle can be used with any tool having a shaft. The handle can be used with a shovel, a rake, a pitchfork, a broom, or the like. The handle is typically removably coupled to the shaft via an integral socket and a fastener, such as a screw. In some embodiments, the handle is part of the tool and is not removable. The handle may be made out of various materials, including one or more of metal, wood, plastic, or the like. In a preferred embodiment, the handle is injection molded as a single unit using a material such as high density polythene (“HDPE”) or high density polythene copolymer (e.g., HDPE with butane or similar comonomer for strength).

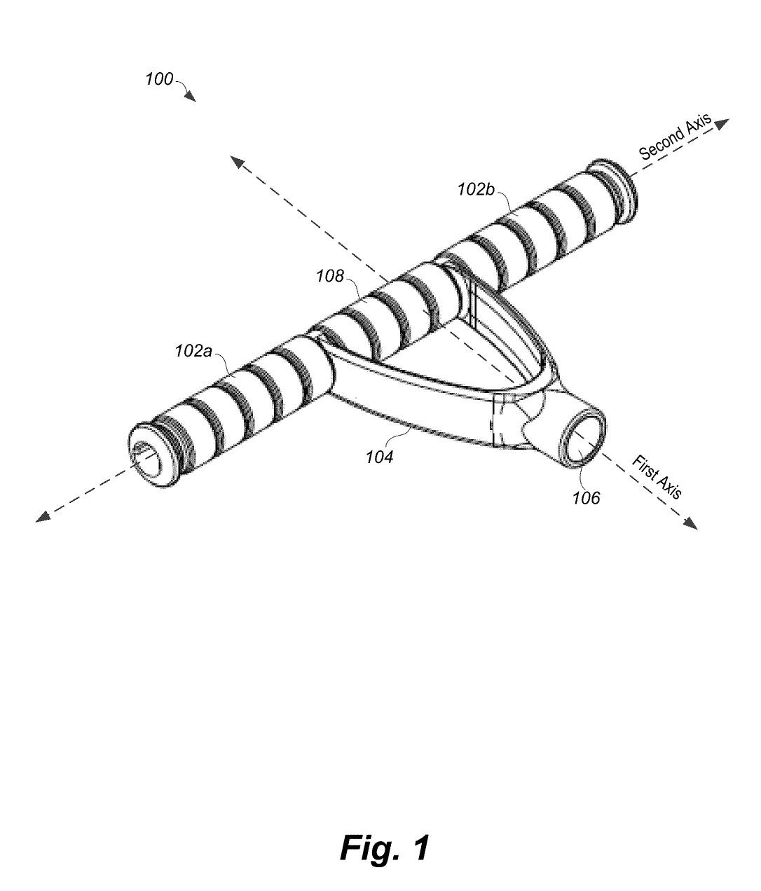

FIG. 1 is a line drawing showing a perspective view of the handle 100 according to a first embodiment. The handle 100 includes a D-grip portion 104, side grips 102a and 102b, and a socket 106. The socket 106 is configured to receive the shaft of a tool and is aligned along a first axis. The D-grip portion 104 includes a center grip 108 that is aligned along a second axis that is perpendicular to the first axis. The side grips 102a and 102b extend along the second axis in opposite directions from one another.

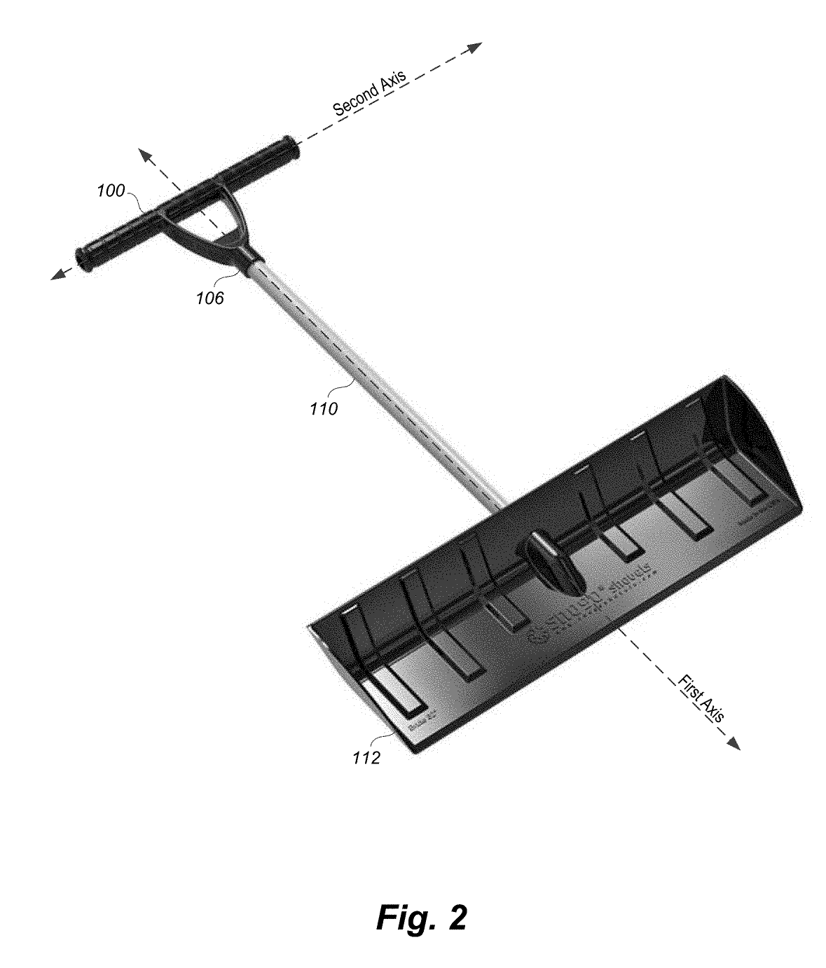

FIG. 2 is an image showing a perspective view of a tool that includes the handle 100 according to the first embodiment. The handle 100 is attached by way of its socket 106 to a shaft 110. The shaft 110 is attached to a tool-head, in this case as shovel head 112. The shaft 110 runs along a first axis. The side grips of the handle 100 run along a second axis that is perpendicular to the first axis.

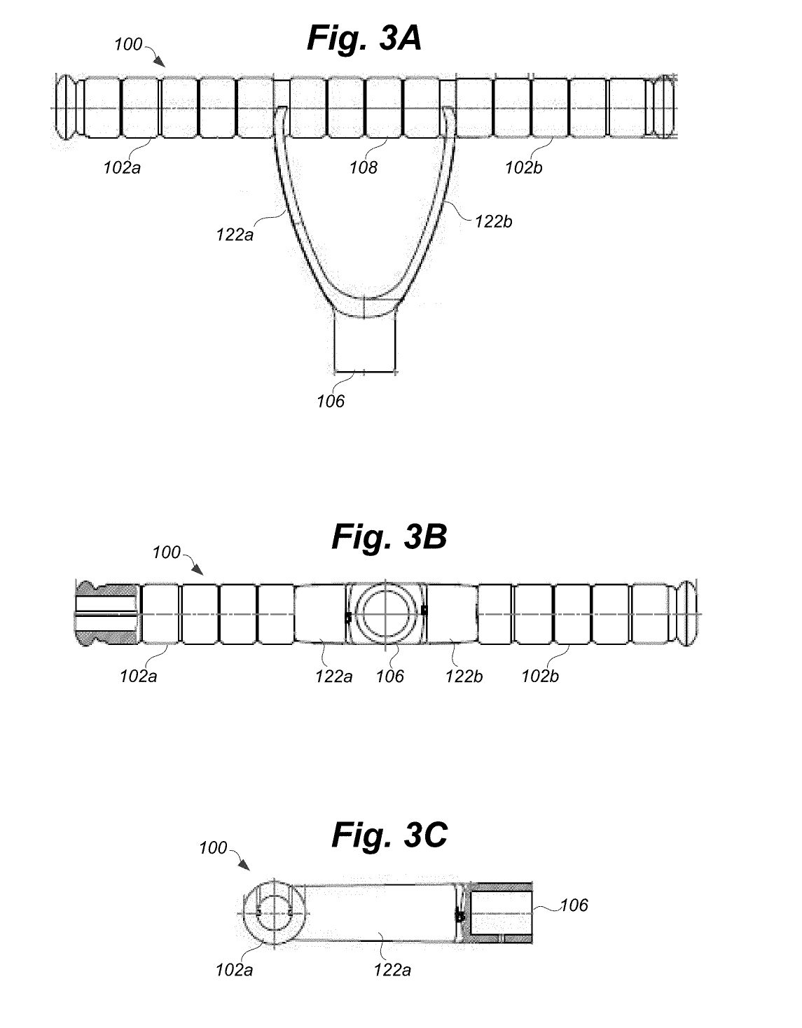

FIG. 3A is a line drawing showing a top plan view of the handle 100 according to the first embodiment. The handle includes side grips 102a and 102b, center grip 108, supports 122a and 122b, and a socket 106. The center grip 108 is substantially cylindrical in shape with a surface that does not contain any perturbances that would extend between fingers of a hand that grasps the center grip 108. The cross section of the center grip 108 is typically circular, ovoid, or rounded square. The support 122a has a first end and a second end, wherein the first end is coupled to the socket 106, and wherein the second end is coupled to a first end of the center grip 108. Similarly, the support 122b has a first end and a second end, wherein the first end is coupled to the socket 106, and wherein the second end is coupled to a second end of the center grip 108.

FIG. 3B is a line drawing showing a front elevation view of the handle 100 according to the first embodiment. In this view, the side grips 102a and 102b, supports 122a and 122b, and socket 106 are visible. The distal end of grip 102a is shown in cutaway view. The grips 102 and 108 may be solid or hollow in cross section.

FIG. 3C is a line drawing showing a left side elevation view of the handle 100 according to the first embodiment. In this view, the side grip 102a, support 122a, and socket 106 are visible. The socket 106 is shown in a cutaway view. The socket 106 typically includes a hollow cross section adapted to receive a tool shaft. The socket 106 is can then be attached to the shaft by way of screw, bolt, glue, or other fastening means. In other embodiments the socket 106 may instead (or in addition) be adapted for insertion into a hollow tool shaft. Note that in some embodiments, the described improved handle does not include a socket or other attachment mechanism at all, such as when the handle is permanently integrated with a tool shaft, such as when a combination of shaft and handle are manufactured as a single unit.

Although the improved handle is described herein in terms of separate elements, such as the D-grip 104, side grips 102, and the like, it is emphasized that some embodiments combine some or all such elements as a single unit, such as through injection molding, stamping, or other manufacturing process. In other embodiments, such elements may be separable, but attached to one another via fastening means, such as screws, rivets, glue or the like.

While embodiments of the invention have been illustrated and described, as noted above, many changes can be made without departing from the spirit and scope of the invention. Accordingly, the scope of the invention is not limited by the above disclosure.

1. A handle for a tool having a shaft that extends along a first axis, the handle comprising:
a D-grip portion that is configured to be removably attached to the shaft of the tool, wherein the D-grip portion includes a grip that is aligned along a second axis that is perpendicular to the first axis;
a first side grip member that is coupled to the D-grip portion and that extends along the second axis; and
a second side grip member that is coupled to the D-grip portion and that extends along the second axis.

2. The handle of claim 1, wherein the D-grip portion includes a socket that is configured to be removably attached to the shaft of the tool, wherein the socket is aligned along the first axis.

3. The handle of claim 2, wherein the socket is hollow in cross section and configured to receive the shaft of the tool, wherein the socket can be removeably attached to the shaft via a screw or other fastener.

4. The handle of claim 1, wherein the D-grip portion comprises:
a center grip that is substantially cylindrical in shape with a surface that does not contain any perturbances that would extend between fingers of a hand that grasps the center grip;
a first support having a first end and a second end, wherein the first end is coupled to the socket, and wherein the second end is coupled to a first end of the center grip; and
a second support having a first end and a second end, wherein the first end is coupled to the socket, and wherein the second end is coupled to a second end of the center grip.

5. The handle of claim 1, wherein the tool is a shovel.

6. A tool, comprising:
a tool-head;
a shaft that is coupled to the tool head and that extends along a first axis; and
a handle, comprising:
a D-handle portion having a socket that is configured to receive the shaft of the tool, the socket aligned along the first axis, wherein the D-handle portion includes a grip that is aligned along a second axis that is perpendicular to the first axis;
a first side grip member that extends along the second axis and beyond the D-handle portion; and
a second side grip member that extends along the second axis and beyond the D-handle portion, wherein the first and second side grip extend in opposite directions from one another.

7. The tool of claim 6, wherein the tool head is one of a shovel, a broom, a rake, or a fork.

8. The tool of claim 6, wherein the shaft is hollow and wherein the socket is configured to be inserted into the shaft.

9. A tool, comprising:
a shaft that extends along a first axis and that has a first end and a second end; and
a handle, comprising:
a D-handle portion attached to the first end of the shaft, wherein the D-handle portion includes a grip that is aligned along a second axis that is perpendicular to the first axis;
a first side grip member that extends along the second axis and beyond the D-handle portion; and
a second side grip member that extends along the second axis and beyond the D-handle portion, wherein the first and second side grip extend in opposite directions from one another.

10. The tool of claim 9, further comprising a tool head that is attached to the shaft.

11. The tool of claim 9, wherein the tool head is removably attached to the shaft by way of a socket.

12. The tool of claim 9, wherein the D-handle portion includes a socket that is configured to receive the shaft of the tool, the socket aligned along the first axis.
